(19) United States
(12) Patent Application Publication
(10) Pub. No.: US 2002/0131678 A1
(43) Pub. Date: Sep. 19, 2002

(54) Wavelength-modular optical cross-connect switch

(76) Inventors: Filippo Bentivoglio Ravasui, Monza (IT); Emilio Casaccia, Monza (IT); Massimo Frascolla, Novara (IT); Engenio Iannone, Milano (IT)

Correspondence Address: Finnegan, Henderson, Farabow, Garrett & Dunner L.L.P., 1300 I Street, N.W., Washington, DC, 20005-3315, US

(21) Appl. No.: 09/893,627

(22) Filed: Jun. 29, 2001

Related U.S. Application Data
(63) Continuation of application No. PCT/EP99/09663, filed on Dec. 7, 1999.
(60) Provisional application No. 60/115,590, filed on Jan. 12, 1999.

(30) Foreign Application Priority Data
Dec. 30, 1998 (EP) 98124833.9

(51) Int. Cl. G02B 6/35; G02B 6/293

(52) U.S. Cl. 385/17; 385/16; 385/24

(57) ABSTRACT

An optical cross connect (OXC) switching fabric that has wavelength and fiber modularity, allowing the OXC fabric to be expanded for new wavelengths and new input fibers with the addition of new modules is disclosed. A plurality of main module switches comprising two-channel add/drop modules are connected to a common junction module switch. For M wavelengths on N fibers switched within the OXC, each of N/2 main modules includes M separate building blocks each comprising two one-channel add/drop module, and the junction module includes M×N/2 selection matrices for N/2 main module and M×N passive optical splitters having one-input and (N/2−1) output. The main module building blocks and junction module selection matrices provide wavelength and fiber modularity and expandability for the OXC.

### BACKGROUND OF THE INVENTION

The present invention relates to the field of optical communication systems, and more particularly to an optical communication network and a multi-wavelength optical cross connect (OXC) switching fabric.

Currently, major optical transport networks are composed of a wide set of different transmission systems with both single and multi-wavelength features. These systems are produced and designed by different vendors, possibly resulting in compatibility and connection problems. To provide a smooth transformation of existing networks and sub-systems into more powerful communication tools, network evolution must be allowed to fully exploit the features of installed optical transmission systems.

In wavelength-division-multiplexed (WDM) networks, for example, not only do the number of WDM channels used differ from system to system, but the wavelength set and Optical Supervisory, Channel (OSC) employed by these various systems also vary from vendor to vendor. Optical Cross-Connect (OXC) switching fabrics provide the features required to ensure that existing networks can interface with more sophisticated or previously incompatible networks. In these environments, the cost-effective introduction of OXC switching fabrics are realized only if some fundamental requirements are fulfilled.

In a generic network, the OXC switching fabric must be able to accommodate at its input/output ports WDM transmission systems with a variable number of wavelength channels, up to a maximum value equal to M. Since it is not possible to build an OXC switching fabric that will operate in all environments, it is assumed that the OXC switching fabric will accommodate up to N input waveguide paths or WDM systems, each having M input channels. In systems with multiple wavelengths, M is the maximum among these numbers.

The OXC is the main network element in the optical path layer for the transport network. Space switching and wavelength switching are two basic schemes that have been adopted for OXC fabrics. For each of these, the optical path layer preferably needs to be modular, scalable, and transparent. Modularity for an OXC includes link modularity and wavelength modularity. Link modularity implies that expanding the switch by adding new input or output fibers does not require changing the OXC structure except for adding some new components. Wavelength modularity, on the other hand, implies that adding new WDM channels to existing fiber links in the switch does not require changing the OXC structure except for the addition of some new components.

Several patent and non-patent references have recognized the importance of the OXC switching fabrics introduction to existing systems. For example, an article entitled “Optical Path Cross-Connect Node Architectures For Photonic Transport Network” by S. Okamoto et al., Journal of Lightwave Technology, vol. 14, no. 6, June 1996, pp. 1410-1422, discloses an optical-path cross-connect architecture that is designed for modularity. The architecture provides an OPXC with a main module and a junction module to interface the groupings of main module components. This paper discloses various OPXC node architectures that are essential components of an optical path network and highlight both wavelength path and virtual wavelength path technologies. The paper concludes that OPXC architecture based on delivery and coupling switches is superior to other OPXC architectures in terms of optical losses, modularity, and upgradeability. As exemplified by FIG. 12 in this paper, however, each interoffice module includes a full M×N delivery and coupling switch, so that the disclosed OPXC node architecture contains only fiber modularity by expanding the number of interoffice modules.

An article entitled “Optical Path Cross-Connect (OPXC) System Architecture. Suitable For Large Scale Expansion” by A. Watanabe et al., Journal of Lightwave Technology, vol. 14, no. 10, October 1996, pp. 2162-2172, discloses an OPXC architecture using multiple interconnected modules. This paper proposes an OPXC architecture suitable for constructing large scale systems with wavelength paths and virtual wavelength paths. The architecture is based on a multi-module concept that uses main modules and junction modules). Expandability of the disclosed OPXC can occur with interoffice modular units and main modules, which all are coupled to a common junction module. As shown in FIG. 8 of this paper, however, the modularity of the disclosed system occurs at a fiber level, rather than a wavelength level, because each interoffice modular unit possesses a full switch matrix for the entire capacity of wavelengths M.

An article entitled “Optical Path Technologies: A Comparison Among Different Cross-Connect Architectures” by E. Iannone and, R. Sabella Journal of Lightwave Technology, vol 14, no. 10, October 1996, pp 2184-2196, surveys several OXC architectures for space switching and wavelength switching matrices. FIG. 7 of this document illustrates the architecture of a wavelength modular OXC using delivery and coupling switches. Wavelength modularity exists because adding a new channel only requires addition of new wavelength converters and a delivery and coupling switch, but does not affect the general OXC architecture. The system, however, includes a full M×N switch matrix for each wavelength within the switch.

U.S. Pat. No. 5,739,935 discloses an optical cross-connect node architecture that interfaces plural optical fiber input and output links, each link containing plural wavelength channels. The '935 patent discloses that the input links are connected to a single optical coupler, or alteratively, to an associated one of plural optical couplers. The '935 patent further discloses that pairs of tunable optical filters and optical wavelength converters are each connected to an output port of the optical coupler, or to each of the plural optical couplers, and perform wavelength channel routing and switching in the wavelength domain.

U.S. Pat. No. 4,821,255 discloses a wavelength-division-multiplexing structure for establishing dedicated high bit rate point-to-point connections between network nodes. The '255 patent discloses that the information transmitted out of any given network node is modulated on a plurality of wavelengths according to destination. These wavelengths are multiplexed and transmitted to a network hub, where they are all demultiplexed, passively rearranged, multiplexed again and then transmitted to the appropriate destinations.

U.S. Pat. No. 5,436,890 discloses an integrated multi-rate cross-connect system that includes a broadband subsystem for processing optical and electrical telecommunication network signals. The system also includes a wideband subsystem for processing wideband level electrical telecommunication signals from the network, from the broadband subsystem, and from a narrowband subsystem. The a narrowband subsystem processes narrowband level electrical telecommunication signals from the network and the wideband subsystem.

U.S. Pat. No. 5,627,925 discloses a wavelength division multiplexing, spatial switching cross-connect structures that are deployed as intermediate nodes of an all optical network to route any input channel on any source fiber to any destination fiber. The nonblocking cross-connect structure comprises a wavelength division demultiplexer, a nonblocking optical structure, and a wavelength division multiplexer for multiplexing together wavelengths having the same destination fiber.

U.S. Pat. No. 5,666,218 discloses a generalized connection network having a first and second sub-network interconnected by a branching circuit with N inputs and N outputs. The branching circuit has N, two-state branching elements interconnected for replicating a signal coupled to any one of the inputs to each of up to N outputs.

U.S. Pat. No. 5,712,932 describes optical cross connects for routing optical traffic between transmission paths in a wavelength division multiplexed optical communication system.

Applicants have observed that existing arrangements for OXC fabrics have provided expensive and inefficient approaches for obtaining wavelength modularity, which is key for expanding existing WDM systems. Optical sub-systems from various sources must be readily interfaced in order to realize the full capacity of an optical communication infrastructure. By requiring the use of multiple, full-scale matrices for each transmitted wavelength, known OXC architectures that have some wavelength modularity still require expensive additions to expand the wavelength capacity of the fabric or have wastefully large matrices. Such systems, as observed by Applicants, do not achieve optimal modularity or cost and size efficiency for current and future applications.

### SUMMARY OF THE INVENTION

Applicants have discovered a wavelength modular architecture for an optical cross-connect switch that provides ready expansion or contraction of switching fabric size for wavelengths with addition or subtraction of simple components. Using a plurality of main modules combined with a common junction module, the cross connect of the present invention provides modular expandability with the addition of sub-module switches within each main module and selection matrices within the junction module. Each sub-module switch corresponds to a wavelength switched by an affiliated main module, and each selection matrix corresponds to a sub-module switch. Increasing or decreasing the number of wavelengths handled by the cross connect simply requires the addition or removal of sub-modules and selection matrices without further disruption of the switch architecture.

Specifically, an optical cross connect for switching optical signals between input optical fibers and output optical fibers consistent with the present invention comprises a plurality of main module (MM) switches. Each main module switch includes input ports coupled to a group of the input optical fibers, output ports coupled to a group of the output optical fibers, and a plurality of sub-module switches each associated to a respective carrier wavelength of the optical signals and being configured to route the optical signals having the respective carrier wavelength between the input ports, the other of the plurality of MM switches, and the output ports. The optical cross connect further comprises a junction module coupled to the sub-module switches and having a plurality of selective matrices each corresponding to a respective sub-module switch and being configured to route a selected drop channel from another of the plurality of sub-module switches in the plurality of MM switches as an add channel to the respective sub-module switch.

In another aspect, the invention is related with a main module switch for use in switching optical signals with a plurality of carrier wavelengths between input optical fibers and output optical fibers in an optical cross connect. The optical cross connect has a junction module for routing some of the optical signals between the main module switch and other identical main module switches. The main module switch comprises: input ports coupled to a group of the input optical fibers; wavelength-division demultiplexers each coupled to one of the input fibers at the input ports; output ports coupled to a group of the output optical fibers; wavelength-division multiplexers each coupled to one of the output fibers at the output ports. The main module switch also comprises a plurality of sub-module switches each corresponding to one of the carrier wavelengths and being configured to route optical signals between the input ports, the other MM switches, and the output ports.

In still another aspect, the invention has to do with an optical telecommunications network, comprising a plurality of transmitting stations for transmitting multiwavelength optical signals; a plurality of receiving stations for receiving said multiwavelength optical signals; a plurality of optical fiber lines for connecting said transmitting stations to a cross-connect apparatus; and a plurality of optical fiber lines for connecting said cross-connect apparatus to said receiving stations. The cross-connect apparatus comprises a plurality of main module (MM) switches. Each main module (MM) switch includes: input ports coupled to a group of the input optical fiber lines; output ports coupled to a group of the output optical fiber lines; and a plurality of sub-module switches each associated to a respective carrier wavelength of the optical signals and being configured to route the optical signals having the respective carrier wavelength between the input ports, the other of the plurality of MM switches, and the output ports. The cross-connect node further comprises a junction module coupled to the sub-module switches and having a plurality of selective matrices each corresponding to a respective sub-module switch and being configured to route a selected drop channel from another of the plurality of sub-module switches in the plurality of MM switches as an add channel to the respective sub-module switch.

In a further aspect, the invention includes a method to cross-connect multiwavelength optical signals between input optical fibers and output optical fibers. The method comprises the steps of: dividing the input and the output optical fibers into groups of fibers, demultiplexing the multiwavelength optical signals from a first group of input fibers into single wavelength optical signals, grouping together single wavelength optical signals of a same nominal wavelength from the first group of input fibers selecting a group of output signals from the single wavelength optical signals of a same nominal wavelength and from signals from a second group of input fibers, different from the first group of input fibers, multiplexing the group of output signals to a group of output optical fibers.

Preferably, the first group of input fibers comprises two optical fibers.

It is to be understood that both the foregoing general description and the following detailed description exemplary and explanatory only and are not restrictive of the invention as claimed. The following description, as well as the practice of the invention, set forth and suggest additional advantages and purposes of this invention.

### BRIEF DESCRIPTION OF THE DRAWINGS

The accompanying drawings, which form part of the detailed description, show embodiments of the invention and, together with the description, explain the principles of the invention.

FIG. 1 is a block diagram of a multimodule optical cross-connect (OXC) switching fabric consistent with an embodiment of this invention.

FIG. 2 is a more detailed block diagram of a modular routing network consistent with this invention.

FIG. 3 is a functional block diagram of a main module switching fabric consistent with an embodiment of this invention.

FIG. 4A is a physical layout of a two channel add/drop switching component consistent with an embodiment of this invention.

FIG. 4B is an illustration showing the functional layout of one channel add/drop switching component consistent with the two channel add/drop switching component of FIG. 4A.

FIG. 5 is a block diagram of a Junction Module consistent with one embodiment of the present invention.

FIG. 6A is block diagram of a 4×2 selective matrix switch consistent with an embodiment of the present invention.

FIG. 6B is block diagram of a 6×2 selective matrix switch consistent with a second embodiment of the present invention.

FIG. 6C is block diagram of a 14×2 selective matrix switch consistent with a third embodiment of the present invention.

FIG. 7 is a block diagram of an optical communication network for implementation of the OXC of FIG. 1.

### DETAILED DESCRIPTION OF THE PREFERRED EMBODIMENTS

The following description of embodiment implementation of this invention refers to the accompanying drawings. Where appropriate, the same reference numbers in different drawings refer to the same or similar elements.

Applicants have invented a modular architecture for an optical cross-connect fabric that provides enhanced flexibility for interconnecting different types of WDM systems with a vastly decreased cost compared to: prior arrangements. Rather than providing a single complex and large matrix for switching numerous channels of a group of optical fibers between each other, an optical cross-connect architecture consistent with the present invention uses an adjustable number of small switch modules combined with a single wavelength-selective junction module. The optical cross-connect architecture provides flexibility in the number of small modular switches employed for a particular application both within main modules and the junction module. A user need only select the number of modular switches required for the interface application rather than commit to a large and complex matrix of conventional devices that have excess capacity. Moreover, the optical cross-connect architecture consistent with the present invention enables simple expansion or contraction of its capacity due to the flexible, modular design.

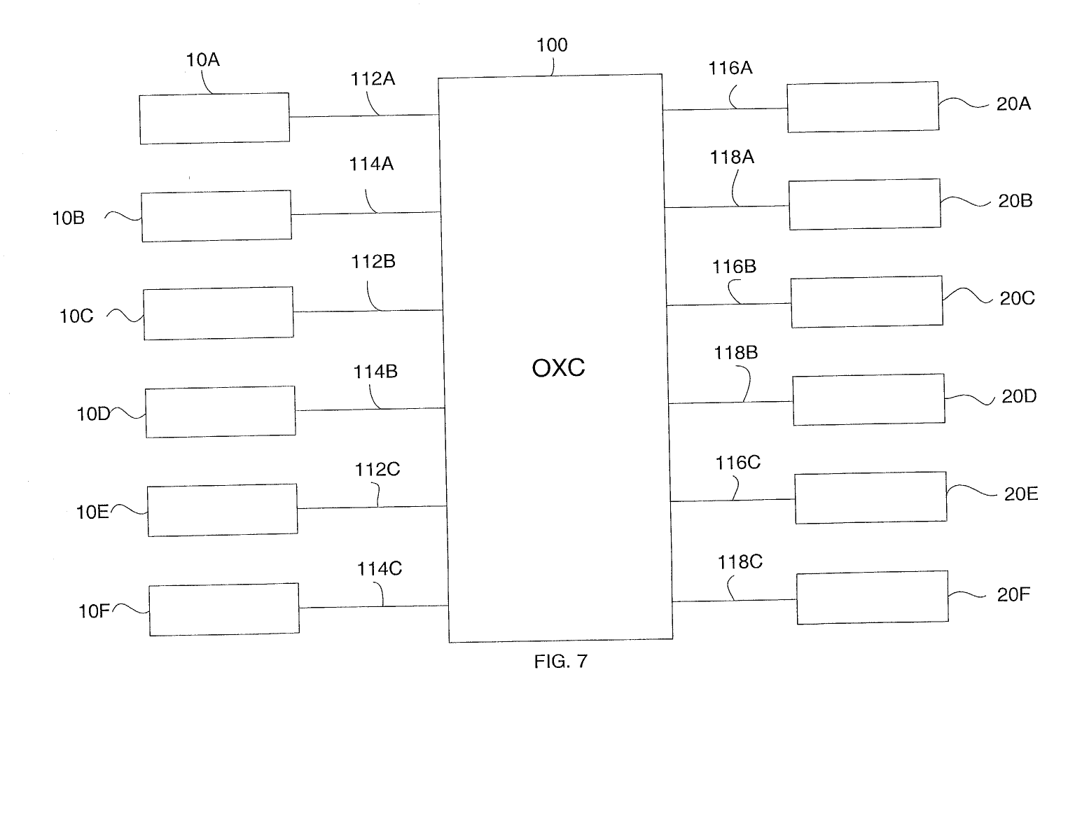

FIG. 7 illustrates a block diagram of a general optical cross-connect and network environment for implementing the present invention. OXC 100 is positioned as a cross-connect apparatus for switching various wavelength channels from a plurality of subsystems 10 and 20. Each of said subsystem 10 comprises a transmitting station for transmitting an optical signal, preferably a multiwavelength optical signal. In this manner, subsystems 10A-F each provide a fiber or link on respective lines 112A-C and 114A-C. Each of said subsystem 20 comprises a receiving stations for receiving an optical signal, preferably a multiwavelength optical signal.

For purposes of the following discussion of the present invention, each of lines 112 and 114 carries two wavelength channel. As a result, OXC 100 receives a total of twelve channels cumulative from subsystems 10 for switching to subsystems 20. In the unidirectional system of FIG. 7, channels from subsystems 10 are switched within OXC 100 to subsystems 20. Optical fibers 116A-C 118A-C each carry two wavelength channels λ₁^{A-F} and λ₂^{A-F} to subsystems 20, such that OXC 100 switches up to twelve incoming channels into twelve different output channels. Wavelengths λ₁^{A-F} and λ₂^{A-F} of the incoming channels may be different for each subsystem 10A-F. Preferably, however, wavelengths λ₁^{A-F} and λ₂^{A-F} of the incoming channels are the same within the pair of lines 112A, 114A, as well as, respectively, within the pair of lines 112B, 114B and within the pair of lines 112C, 114C.

Said first and second fiber optic lines may comprise intermediate stations of amplification of the optical signals. In particular, optical amplifiers may be arranged at the ends of the fiber optic lines, and can be associated with the inputs and outputs of OXC 100.

In accordance with the present invention, an optical cross connect for switching optical signals between input optical fibers and output optical fibers, includes a plurality of main module (MM) switches and a junction module. Each MM switch includes input ports coupled to a group of the input optical fibers, output ports coupled to a group of the output optical fibers, and a plurality of sub-module switches.

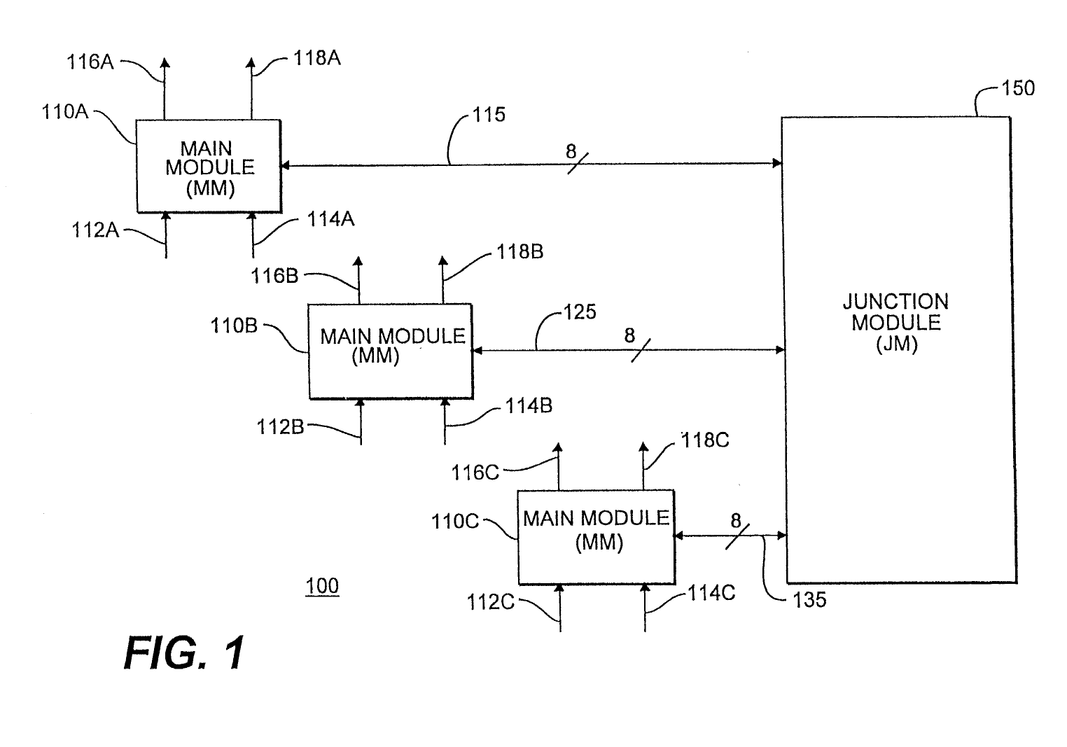

FIG. 1 is a high-level block diagram of a multi-module optical cross-connect (OXC) switching fabric 100 consistent with an embodiment of this invention. Switching fabric 100 includes two main building blocks, which are Main Module (MM) switches 110 and a Junction Module (JM) switch 150. In this embodiment, only three MMs 110A-C are shown for exemplary purposes, but multiple MMs may be added to connect to JM 150. The connection of additional MMs to JM 150 provides one aspect of the modularity and flexibility that is important to future expansion of a network or system employing optical cross connect fabrics, as explained in further detail below.

MM 110, representative of any of MM 110A-C, is an OXC switching module having two multi-channel input ports 112 and 114 and two multi-channel output ports 116 and 118. Although the disclosed embodiment of MM 110, having two input ports and two output ports is preferred, it will be understood by those of ordinary skill in the art that MM 110 can be designed to have greater than two inputs and greater than two outputs depending on the requirement of the implementation. Input ports 112 and 114 are coupled, for example, to two subsystems 10 of an optical communication network, while output ports 116 and 118 are coupled to two sub-systems 20. The set of MMs constituting OXC switching fabric 100 should be able to route a signal entering from input ports 112 and 114 of a given MM 110 towards any output port 116 and 118 of that MM 110 or of another MM 110. More particularly, MM 110A can help route a wavelength entering, for example, at 112A to an output path on one of lines 116A-C or 118A-C, depending on system design. To accomplish this inter-module routing, MMs 110A-C are mounted on JM 150 via optical ports 115, 125, and 135, respectively. In the exemplary embodiment the optical ports connecting the MMs and the JM consist of eight optical paths (e.g., optical fibers) for each MM.

According to this embodiment, the maximum number of MMs in the OXC switching fabric 100 depends only on the dimensions of JM 150, which is also modular. As described in the following, JM 150 includes a modular active section and a passive section that is preferably sized according to maximum foreseen requirements. The junction module passive section preferably omits active components in its structure, which keeps its cost below comparable switch matrix devices. Initially, OXC switching fabric 100 is equipped with a limited number of MMs such as the three shown in FIG. 1. As more input/output fibers are required, for example, when an additional sub-system is added to the cross-connect switch, fabric 100 is upgraded with additional MMs to provide fiber modularity for fabric 100. In the arrangement detailed here, each main module 110 receives two optical fibers or links 112 and 114 and likewise provides two output fibers 116 and 118. Thus, the addition of two fibers or links to the switch requires the addition of one more MM. An increased number of interfacing links per main module beyond two may be used in alternate embodiments. For purposes of illustration, the fibers in this embodiment each carry two wavelengths λ₁ and λ₂ from different subsystems for switching within fabric 100. Although implementation of the present invention may involve fibers that carry greater than two wavelengths per fiber, discussion of the preferred embodiment herein centers on the switching for wavelengths λ₁ and λ₂. In a telecommunication optical network for multiwavelength signals the number of wavelength can be in general greater than two.

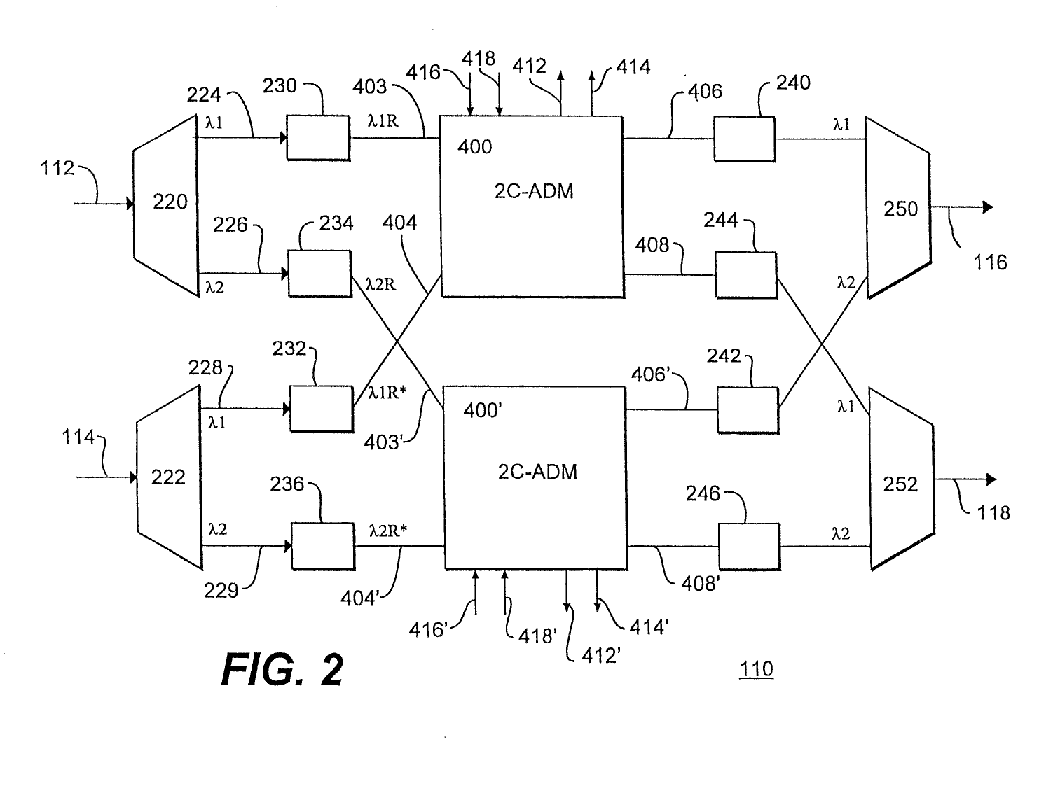

FIG. 2 is a more detailed block diagram of main modules 110A-C of FIG. 1 in accordance with one embodiment of this invention having two wavelengths λ₁ and λ₂ per input fiber 112 and 114. Each of MM 110A-C are preferably identical in function, which leads to ease of expansion, interchangeability, and modularity at a link and fiber level. Consequently, a generic MM 110 is depicted that is equivalent to each of modules 110A-C in FIG. 1.

In FIG. 2, each MM 110 includes a wavelength demultiplexer 220 and 222 for respective input lines 112 and 114 and a wavelength multiplexer 250 and 252 for each destination output line 116 and 118.

FIG. 2 shows that each MM 110 includes 2 sub-modules referred to as two-channel add/drop modules (2C-ADM) 400 and 400′. Throughout the present work two-channel ADMs (or n channel ADMs, in the less preferred case of MM 110 having n inputs and n outputs, with n greater than 2) are referred to also as sub-module switches 2C-ADM 400 and 400′ preferably have substantially identical structure and function that permits their use as modular expansion and replacement units. Each module 400 and 400′ is provided within MM 110 for switching two channels. In the exemplary embodiment the channels switched by each 2C-ADM have identical wavelengths. However, the channels switched by each 2C-ADM may differ in wavelength, depending on the characteristics of the input and output signal adapters. To account for the above and to ensure full modularity 2C-ADMs 400 and 400′ are preferably wavelength independent.

In the embodiment of FIGS. 1 and 2 having two channels per link, two add/drop modules 400 and 400′ are required, where module 400 switches channels λ₁ from fiber 112, and module 400′ switches channels with carrier wavelength λ₂ from fiber 112. The switching fabric of the present invention provides wavelength modularity in this interchangeable 2C-ADM approach. If the separate sub-systems coupled to respective fibers 112 and 114 add additional channels, such as a channel with carrier wavelength λ₃, the architecture for MM 110 would require an additional 2C-ADM identical to 400 and 400′. The additional 2C-ADM would collect channels for λ₃ from multiplexers 220 and 222, that are able to separate λ₃ too, for switching within junction module 150 in a fashion described below.

In accordance with the embodiment of the present invention illustrated in FIG. 2, input optical fibers or links 112 and 114 each carry two wavelengths λ₁ and λ₂ for switching within the OXC fabric 100. Demultiplexer 220 receives λ₁ and λ₂ from fiber 112 and separates the two wavelengths for passage, respectively, on optical paths 224 and 226. Demultiplexer 222 separates λ₁ onto optical path 228 and onto optical path 229.

Each of optical paths 224, 226, 228, 229 may includes for example, an input signal adapter 230, 232, 234, and 236 for each input wavelength signal carried by lines 112 and 114.

Input signal adapters can comprise a wavelength converter, a device for amplifying the optical signal, a device for reshaping the optical signal or a device for regenerating the optical signals, or any combination of the above. In the embodiment illustrated in FIG. 2, the adapters perform all the four above cited functions.

Known devices for achieving this aim include direct modulation using an optical laser source and external modulation using a Mach-Zehnder interferometer, for example. U.S. Pat. No. 5,267,073 and U.S. Pat. No. 5,504,609, among others, describe these known devices.

Input signal adapters are optional in the OXC 100 and may include alternative devices such as optical amplifiers for boosting the optical signals for output. One of ordinary skill in the art will appreciate that the use of adapters 230, 232, 234, and 236 are optional to performance of the switching characteristics of OXC 100.

The wavelengths λ_{1R} and λ_{2R} at the output of the input signal adapters 230, 232, 234 and 236 may have the same values of λ₁ and λ₂ or they may have different values. Moreover, it is possible to have λ_{1R} with the same value of λ_{2R} because the path of each wavelength within the OXC is different from others wavelength.

Thus, after passing through adapters 230 and 232, both signals from fiber 112 and 114 having nominal carrier wavelength λ₁ are collected into wavelength sub-module 400. As well, signals from fibers 112 and 114 having nominal carrier wavelength λ₂ are collected in wavelength sub-module 400′. In a preferred embodiment, wavelength sub-module switches 400 and 400′ provide routing of signals received from input fibers 112 and 114 to other main modules 110 via junction module 150. Connection to junction module 150 occurs through paths 412 and 414, while signals sent from junction module 150 to wavelength sub-module 400 pass through paths 416 and 418.

Output signal adapters 240, 242, 244, and 246 can be coupled to output ports 406, 408, 406′ and 408′ of 2C-ADMs 400 and 400′.

Output adapters 240, 242, 244, and 246 receive signals from sub-modules 400 and 400′ to send the optical signals to the output demultiplexers 250 and 252.

Output signal adapters can comprise a wavelength converter, a device for amplifying the optical signal, a device for reshaping the optical signal or a device for regenerating the optical signals, or any combination of the above, depending upon the insertion loss of the various modules within the optical cross connect and on the characteristics of the output fiber lines. In the embodiment illustrated in FIG. 2, the adapters perform all the four above cited functions, and in particular convert signal wavelengths λ_{1R} and λ_{2R} respectively to wavelengths λ₁ and λ₂.

As with the input adapters, these output adapters are optional in the OXC 100 and may include alternative devices such as optical amplifiers for boosting the optical signals for output. One of ordinary skill in the art will appreciate that the use of output signal adapters 240, 242, 244, and 246 are optional to performance of the switching characteristics of OXC 100.

Multiplexers 250 and 252 combine signals of sub-modules 400 for transmission on output fibers 116 and 118. In particular, multiplexer 250 combines wavelength λ₁ from sub-module 400 via adapter 240 with wavelength λ₂ from sub-module 400′ via adapter 242 for a multiplexed output on fiber 116. Similarly, multiplexer 252 combines wavelength λ₁ from sub-module 400 via adapter 244 with wavelength λ₂ from sub-module 400′ via adapter 246 for a multiplexed output on fiber 118.

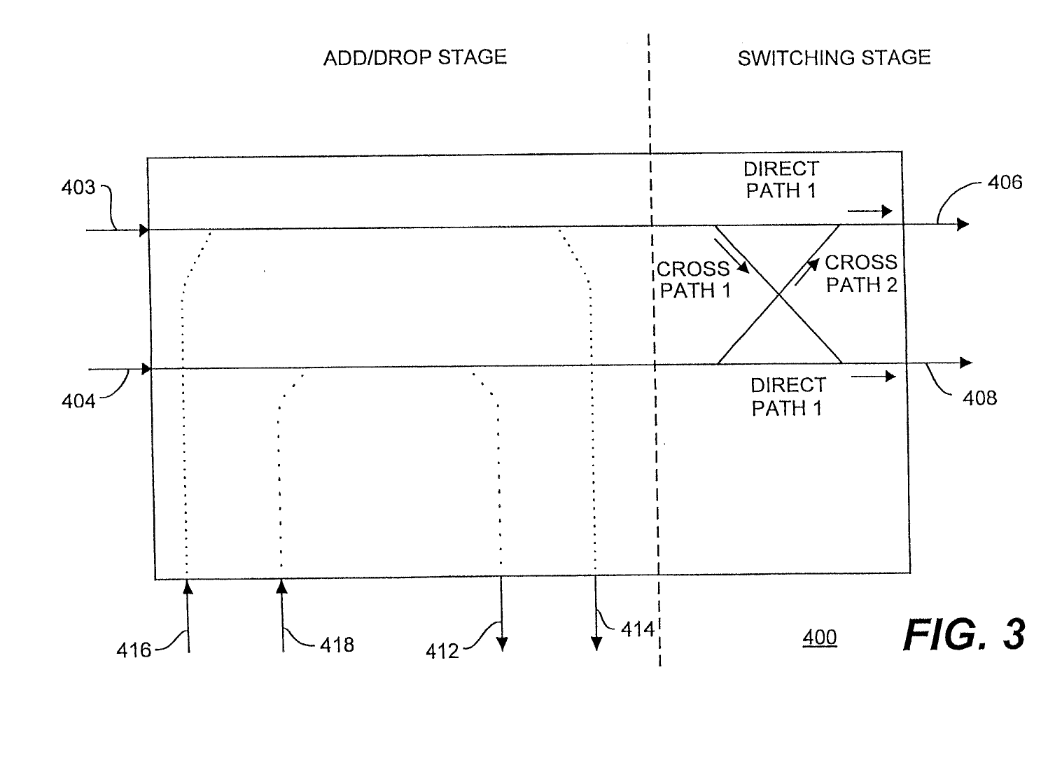

FIG. 3 is a functional layout of 2C-ADM 400 (and likewise 2C-ADM 400′) and, in accordance with this embodiment, 2C-ADM 400 has an acid/drop stage and a switching stage. The add/drop stage has two optical input ports 403 and 404 that receive optical input signals having the same wavelength from different optical sub-systems via fibers 112 and 114.

As an example, input port 403 may receive λ_{1R} from adapter 230 in FIG. 2, while input port 404 may receive λ_{1R}* from adapter 232.

In the add/drop stage, sub-module 400 may drop either or both channels λ_{1R} or λ_{1R}* to JM 150 for switching for output through a different sub-module 400. Connection to JM 150 for dropping any wavelength exists through ports 412 and 414. Alternatively, sub-module 400 may pass either or both channels λ_{1R} or λ_{1R}* directly to its switching stage for output on lines 406 or 408. Since MMs 110 are each wavelength selective, the wavelength channels not selected and switched by the particular matrix within wavelength sub-module 400 are routed via drop ports 412 and 414 and JM 150 to the appropriate matrix within a different 2C-ADM 400 in a manner described further below. In other words, the wavelength channels dropped correspond to those channels not switched by the initial 2C-ADM 400. Add/drop stage also includes two signal add ports 416 and 418 optically coupled to JM 150 that may each accept signal wavelengths λ_{1R} or λ_{1R}* from another MM 110 via JM 150. Preferably, add input ports 416 and 418 and drop output ports 412 and 414 are isolated with no physical connection between them. Further, add/drop operations on signals received at input port 403 are independent of those that occur at input port 404.

The switching stage of 2C-ADM 400 includes two optical output ports 406 and 408 for transmitting an optical channel signal received from the add/drop stage toward an output of MM 110. The switching stage within 2C-ADM 400 enables the separate channels having the same wavelength to be switched to the appropriate output port 406 or 408 for passage to desired fiber 116 or 118. In this way, the switching stage has two functional states, a direct path for coupling port 403 to port 406 and part 404 to port 408, and a cross path for coupling port 403 to port 408 and port 404 to port 406.

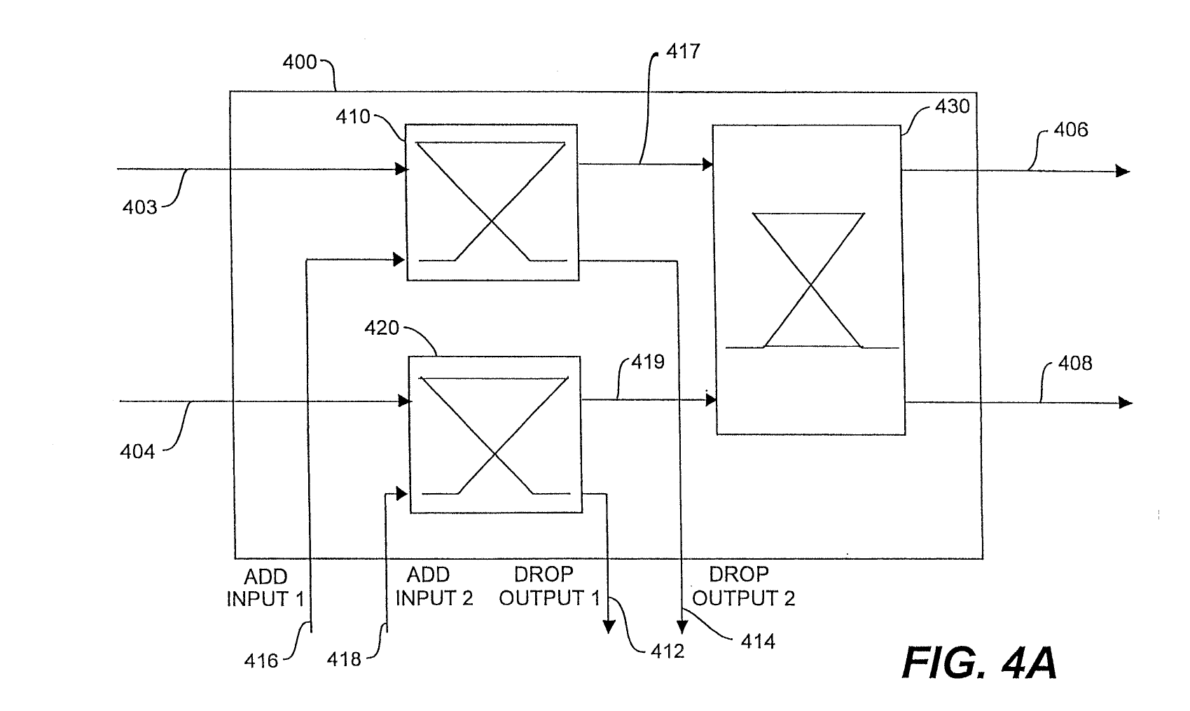

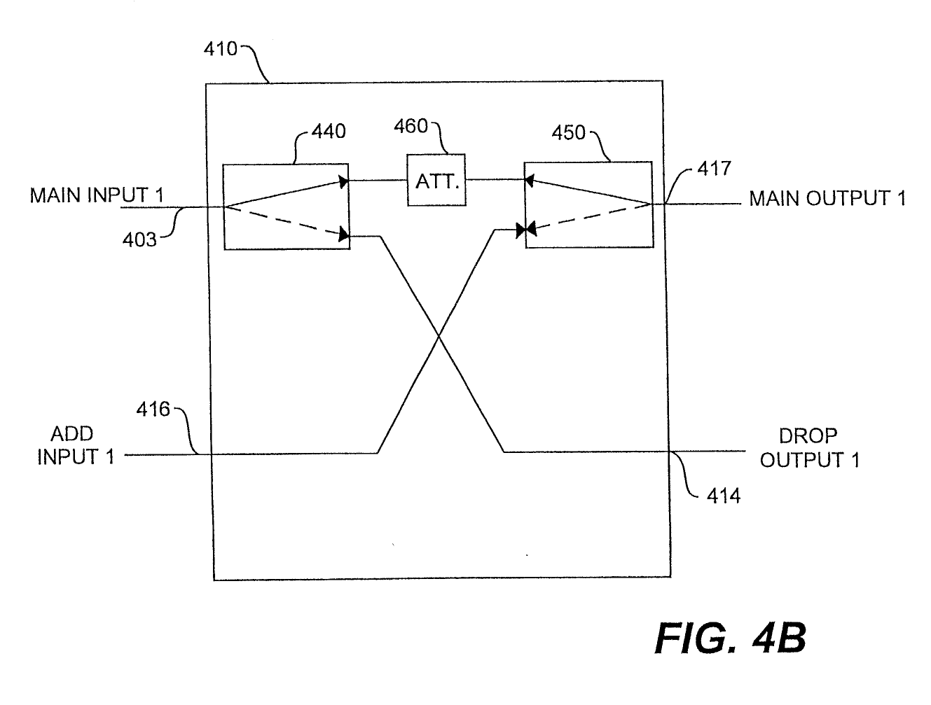

FIG. 4A shows a block diagram of a preferred physical layout of 2C-ADM 400 consistent with an embodiment of this invention. In FIG. 4A, the add/drop stage of FIG. 3 may be implemented using two building blocks comprising single channel add/drop modules (1C-ADM) 410 and 420. In this embodiment, 1C-ADM 410 and 420 are identical and configured to operate in the same functional manner. The 2C-ADM 400 also includes a 2×2 optical switch 430 for switching between the outputs of 1C-ADM 410 and 420.

FIG. 4B is an illustration showing the functional layout of 1C-ADM 410 and 420 consistent with this invention. In FIG. 4B, 1C-ADM 410 has a main input port 403, an add input port 416, a first 1×2 optical switch 440, a second 1×2 optical switch 450, a settable optical attenuator 460, a main output port 417 and a drop output port 414. It should be noted that identical elements for the signal ports reflect that 1C-ADM 410 and 420 serve as subcomponents or building blocks of 2C-ADM 400.

In this embodiment, 1C-ADM 410 has three possible operating states. In the first state, signals received at input port 403 are passed directly to output port 417 without any attenuation of the signal by attenuator 460. In the second state, signals received at input port 403 are passed to output port 417 with an attenuation signal introduced by attenuator 460. In the third state, a wavelength channel is dropped or removed from the optical signal and routed to drop output port 414. Preferably, routing switches 440 and 450 are configured to operate simultaneously at the issuance of an external command. This feature ensures that 1C-ADM 410 preferably has only a pass (bar) state or an add/drop (cross) state, not a hybrid of these two states. Optical attenuator 460 is settable to an ON or an OFF condition via electronic control, as is readily known to those of ordinary skill in the art. Attenuator 460 provides the possibility to insert an optical attenuation in order to disequalize the optical channel that is added or dropped with respect to those that pass directly from the main input 403 to the main output 417.

Optical switch 430 is a conventional (2×2) optical switch. It has two functional states, a bar state for coupling input port 417 to output port 406 and input port 419 to output port 408 and a cross state for coupling input port 417 to output port 408 and input port 419 to output port 406.

Overall, 2C-ADM 400 is a modular device for use in interchangeable quantities within fabric 100, but itself has a modular construction of building blocks 410, 420 and 430. Making a structure for 2C-ADM 400 is within the knowledge of those of ordinary skill in the art. Conventional opto-mechanical, electro-optical magneto-optical, acousto-optical technologies, for example, can be used for 1C-ADMs 410 and 420 and in particular for (1×2) switches 440 and 450, as well as for 2×2 switch 430. Preferably, thermo-optics or other planar-optics technologies are used. Optical coupling between the various components within 2C-ADM 400 can be accomplished, for example, by sections of optical fibers or, preferably, in an integrated manner, by a planar-optics technology. Each module 400 may be identically manufactured into an optical chip or substrate for mounting on MM 110 for a particular implementation.

MM 110 may comprise a single main board or substrate capable of holding a variable number of 2C-ADM 400. A variable number of wavelength demultiplexers and multiplexers such as 220, 222 and 250, 252 can be advantageously arranged on the same main board or substrate. Signal adapters 230-236 and 240-246 can be either integrated on a same main board with the other components and modules of MM 110 or can be organized as separate modules and coupled to the main board by optical paths, e.g., optical fibers or waveguides. Optical connectors can be provided to ensure a detachable connection.

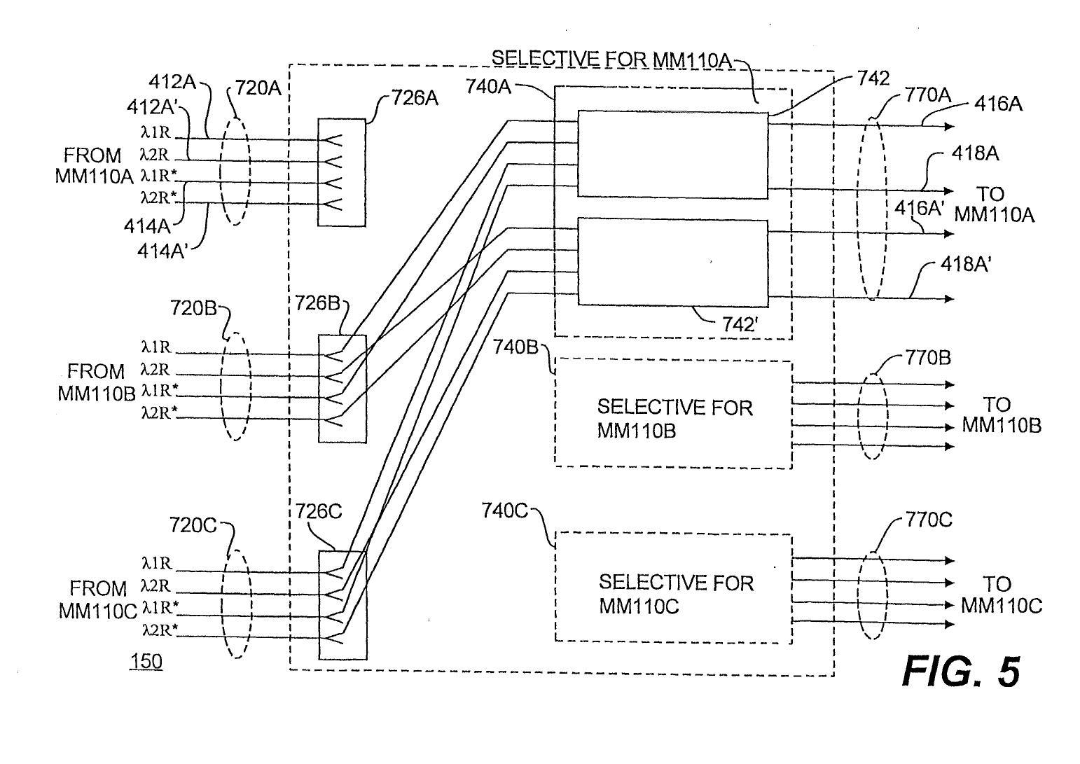

FIG. 5 is a block diagram of a JM 150 structure and possible signal routing consistent with one embodiment of this invention. In accordance with the present invention, a junction module coupled to the sub-module switches has a plurality of selective matrices each corresponding to a respective sub-module switch and is configured to route a selected drop channel from another of the plurality of sub-module switches in the plurality of MM switches as an add channel to the respective sub-module switch.

Preferably, JM 150 has one input port 720A, 720B, and 720C and one output port 770A, 770B, and 770C for a maximum number of MM 110 that is expected to be installed. Therefore, if K is the maximum number of MMs 110 that can be installed on JM 150 (so that the maximum number of input and output lines is N=2K), then JM 150 has K input ports and K output ports. Further, in this embodiment, JM 150 can route each of the M channels entering an MM towards another selected MM and therefore, each input port preferably includes 2M fiber leads, i.e., the maximum number of channels entering a single MM. In addition, since the channels at the output of MM 110 may enter any other MM, JM 150 has output ports 770A-C that each includes 2M fiber leads. In the example of FIG. 5, input port 720A coupled to MM 110A receives wavelengths λ_{1R}, λ_{1R}*, λ_{2R}, and λ_{2R}* on lines 412A, 414A, 412A′, and 414A′ respectively.

Inside JM 150, a path for each input channel, λ_{1R}, λ_{1R}*, λ_{2R}, and λ_{2R}*, for example, is distributed to the output ports of JM 150. This distribution is initiated by a set of 2M passive splitters 726A-C, each having one input and (K−1) outputs, that divide the wavelength channels to the inputs of a set of asymmetric switch matrices 740A-C, one for each output port 770A-C. The connection of paths from MM 110B and 110C to MM 110A is shown via splitters 726B and 726C, respectively, in FIG. 5. Although only connections between splitters 726B and 726C to asymmetric switch matrix 740A are shown in FIG. 5, it will be understood that JM 150 includes further paths between splitters 726A, 726B, and 726C, and asymmetric switch matrices 740A, 740B, and 740C.

Preferably, switching matrices 740A, 740B, and 740C inside JM 150 are pure selection devices that select four channels among the eight channels that are provided to it (in the example with K=3). Each asymmetric switch matrix 740A-C includes a pair of selection matrices 742 and 742′, one for each wavelength handled by OXC fabric 100. Selection matrix 742 selects the two channels of wavelength λ_{1R} for a particular 2C-ADM 400, while selection matrix 742′ selects the two channels of wavelength λ_{2R} for the same sub-module 400. In particular, selection matrix 742 in FIG. 5 receives four possible λ_{1R} channels from MM 110B and 110C and selects one of the λ_{1R} channels for output on line 416A to MM 110A and selects another of the λ_{1R} channels for output on line 418A to MM 110A. Selection matrix 742′ receives four possible λ_{2R} channels from MM 110B and 110C and selects two of them for MM 100A on output lines 416A′ and 418A′. It will be readily apparent that selection matrix 740B performs the analogous switching for channels from MM 110A and MM 110C for routing to MM 110B. Likewise, selection matrix 740C will perform analogous switching for channels from MM 110A and MM 110B for routing to MM 110C.

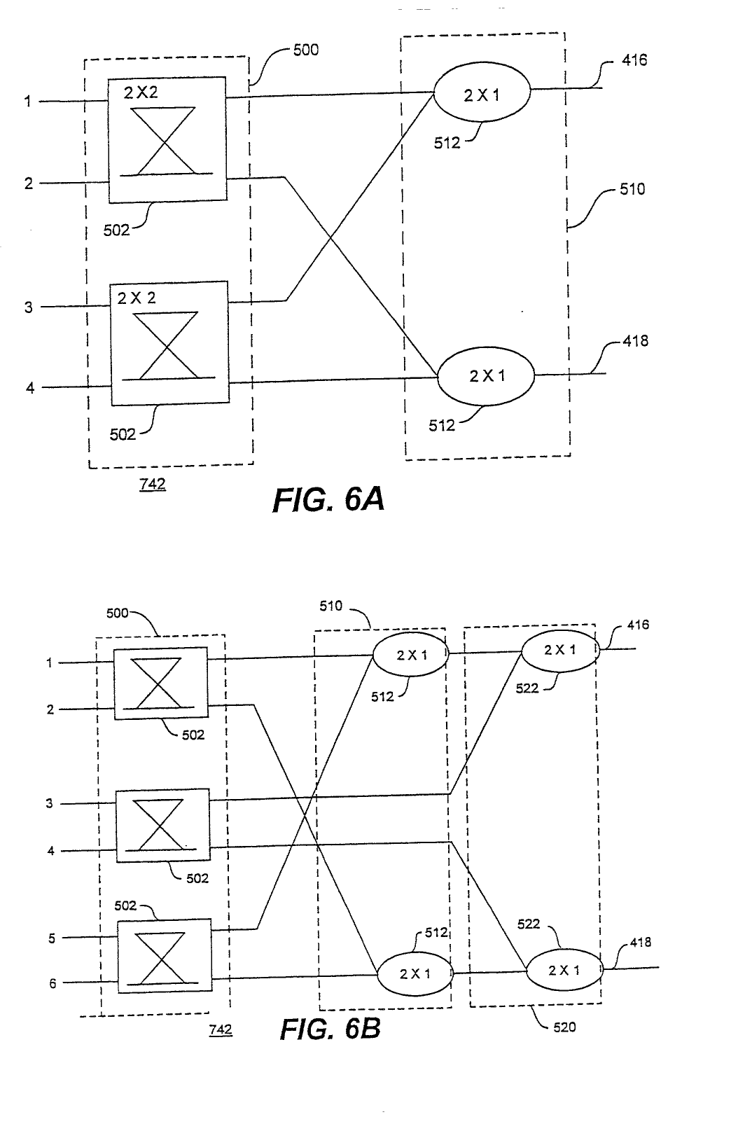

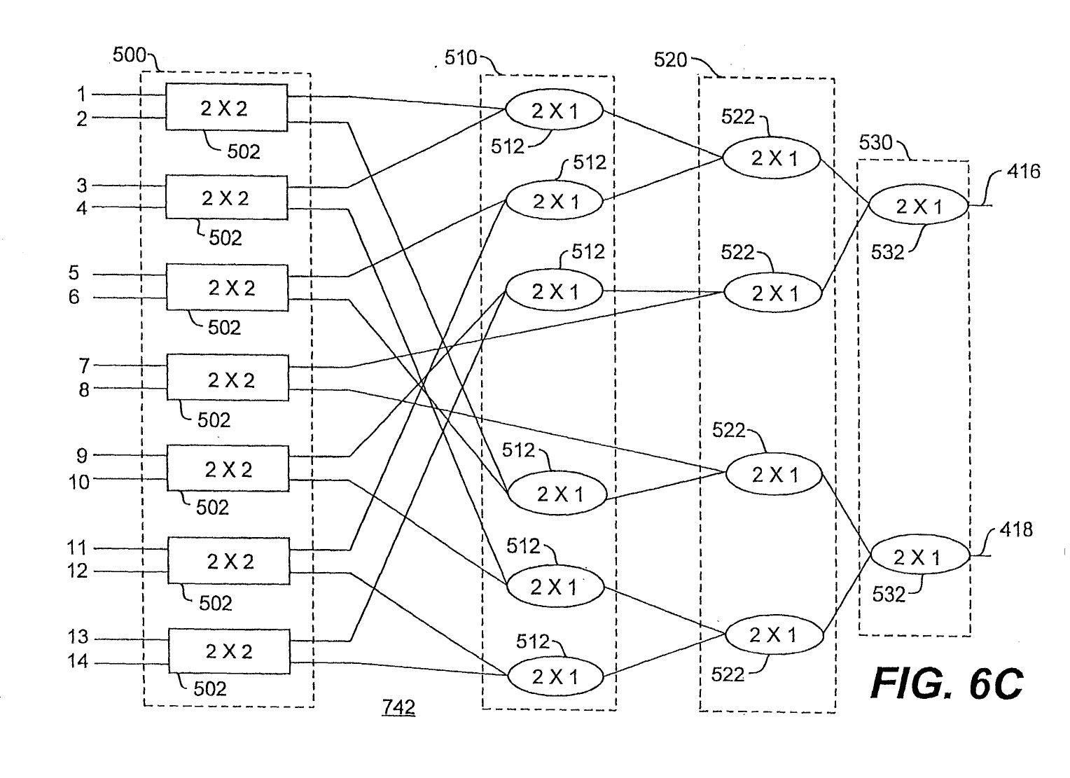

FIG. 6A shows a block diagram of a preferred arrangement for selection matrices (SM) 742 and 742′. As with 2C-ADM 400 and 400′, selection matrices 742 and 742′ are substantially identical in structure and, function, which aids in the expandability and modularity of the present invention. Adding another wavelength on one or more of the sub-systems feeding into the switch fabric through fibers 403 and 404 so as to increase the maximum number of wavelengths, simply requires the addition to the junction module of another selection matrix, identical to 742 and 742′ in structure, for each of the asymmetrical switch matrices 740A, 740B, and 740C, together with the addition to each MM of another 2C-ADM like 400 and 400′ described above, and of signal adapters, if required by the adopted system implementation.

In the embodiment of FIG. 6A, SM 742 includes a first stage 500 and second stage 510. First stage 500 includes two (2×2) optical switching elements 502 having a bar state and a cross state. Optical switching elements 502 are, for example, similar to switch element 430 of 2C-ADM 400. Each of switching elements 502 receives two optical channels and routes the channels to the appropriate location in second stage 510. Second stage 510 includes two (2×1) optical switching elements 512 for routing the selected optical channel to a particular output port 416 and/or 418.

The asymmetric matrix 742 is configured to select two from the 2(K−1) optical channels and send them, in a predetermined and selectable order, to the two available output ports 416, 418.

FIG. 6B is block diagram of a (6×2) selection matrix consistent with another embodiment of this present invention. The architecture of FIG. 6B is applicable when the expandable OXC fabric 100 is designed for use with four input fibers instead of three. In this embodiment, SM 742 includes a first stage 500, a second stage 510 and a third stage 520. First stage 500 includes three (2×2) optical switching elements 502, each receiving two optical channels and routing the channels to the appropriate location in second stage 510. Second stage 510 includes two (2×1) optical switching elements 512, each receiving two optical channels routed from first stage 510 for routing to a switching element in third stage 520. Third stage 520 includes two (2×1) optical switching elements 522 for routing the selected optical channels of the 6 inputs to output port 412 and/or 414.

FIG. 6C is block diagram or a (14×2) switching fabric or matrix 742 consistent with another embodiment of the present invention. The architecture of FIG. 6C is applicable in the situation where expandable OXC fabric 100 is implemented with eight input fibers rather than three or four described above. In this embodiment, SM 742 includes a first stage 500, a second stage 510, a third stage 512, and a fourth stage 530. First stage 500 includes seven (2×2) optical switching elements 502, each receiving two optical channels and routing the channels to the appropriate location in second stage 510. Second stage 510 includes six (2×1) optical switching elements 512, each receiving two optical channels routed from first stage 500 for routing to a particular switching element in third stage 520. Third stage 520 includes four (2×1) optical switching elements 522 for routing the selected optical channel to a particular switching element in fourth stage 530. Fourth stage 530 includes two (2×1) optical switching elements 532 for routing the selected optical channel to a particular output port.

As described, JM 150 includes an active section, i.e., asymmetric switch matrices 740, and a passive section comprising passive splitters 726 and the optical paths between the passive splitters 726 and the asymmetric switch matrices 740. As with MMs 110, making a structure for JM 150 is within the knowledge of those of ordinary skill in the art, tut preferred structures include planar-optics or fiber optics technologies for the passive section and thermo-optics, opto-mechanics, electro-optics, magneto-optics, acousto-optics technologies for the active section. For instance, JM 150 may comprise a single board or substrate capable of holding a variable number of MMs 110. Alternatively, JM 150 may comprise a single circuit board, a substrate or a group of circuit boards mounted into a backplane housing other boards or substrates for each of the MMs 110. In this configuration, expansion or contraction of OXC 100 can occur through the simple insertion or extraction of an MM 110 board from the backplane for fiber modularity. Wavelength modularity can be attained, for example, through the insertion or extraction of additional boards in the backplane for sub-modules 400 and 742 or of chip-sized components within individual boards for MMs 100. The upper limit of the upgradeability of the JM is the space on the single board or substrate or in the backplane that has to be determined when said JM is planned.

In addition to the switching components described above, it will be apparent that OXC 100 includes control logic (not shown) for dictating the switching patterns employed by the MMs 110 and JM 150 for a given implementation. This control logic may be in the form of a centralized computer for monitoring and controlling the routing and performance of all optical signals within OXC 100. Eased on the particular application, the control computer will instruct the optical devices such as 1C-ADM 410 and 420 in each MM 110 whether and how to switch incoming optical signals on lines 403 and 404. These commands may force 1×2 optical switches 440 and 450 into either a bar or a cross condition, while also dictating whether optical attenuation is added using attenuator 460. Similarly, the control logic selects the route for optical signals through selection matrices 742 using each of the 2×2 optical switches and 2×1 optical switches illustrated in the embodiments of FIGS. 6A-C. Programming of the central computer permits flexible routing of optical signals Within the modular structure of OXC 100 from any input link 112A-C or 114A-C to any output link 116A-C or 118A-C.

Accordingly, the present invention provides a wavelength-modular cross-connect switch that can be readily expanded or contracted to suit the number of channels transmitted by its affiliated subsystems. The sub-modules within each main module correspond to the number of switched wavelengths by the main module and can be easily added or removed. Thus, the switch need not include wasteful excess capacity for unused channels as in conventional designs. As well, wavelength modularity arises from the relationship of the selective matrices to the number of switched channels. Adjusting the quantity of these matrices as with the sub-module switches allows the cross connect of the present invention to achieve optimal size for a given application.

While the present invention has been described in terms of one-way optical communication, it may also be used in bi-directional systems. An OXC switching fabric having K input ports and K output ports is adequate to manage K bi-directional paths, for example. If K is high, however, bi-directional routing may be better managed by two OXC switching fabrics with K/2 ports each (one for each direction of the traffic) controlled by the same routing platform or mechanism.

Bi-directional OXC switching fabrics can interface two types of bi-directional transmission systems: double-fiber and single-fiber systems. In double-fiber systems, the same wavelength is used for the corresponding path in the two directions since two different fibers are available. A single-fiber system is usually designed such that half the channels in the fiber travel in one direction, while the others move in the opposite direction.

A large number of different OXC switching fabric families can be realized with the modular building blocks described above. A bi-directional OXC switching fabric in accordance with the disclosed embodiments can therefore be described as a bi-directional, single switch fabric (BS-OXC) or a bi-directional, double switch fabric (BD-OXC). The BD-OXC switching fabric would include two single switch fabrics controlled by the same switching platform, with each handling in-coming or out-going traffic, respectively.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An optical cross connect for switching optical signals between input optical fibers and output optical fibers, comprising:
a plurality of main module (MM) switches each including
input ports coupled to a group of the input optical fibers,
output ports coupled to a group of the output optical fibers and
a plurality of sub-module switches each associated to a respective carrier wavelength of the optical signals and being configured to route the optical signals having the respective carrier wavelength between the input ports; the other of the plurality of MM switches, and the output ports; and
a junction module coupled to the sub-module switches and having
a plurality of selective matrices each corresponding to a respective sub-module switch and being configured to route a selected drop channel from another of the plurality of sub-module switches in the plurality of MM switches as an add channel to the respective sub-module switch.

2. The optical cross connect of claim 1, wherein each respective sub-module switch includes:
an add/drop stage having an add port configured to receive an add channel from the another sub-module switch via the junction module and a drop port configured to output a drop channel to one of the plurality of sub-module switches via the junction module; and,
a switching stage configured to route one of the optical signals having the respective carrier wavelength or the add channel to any one of the output ports.

3. The optical cross connect of claim 2, wherein the add/drop stage includes two one-channel add/drop multiplexers each having a main input, an add input, a main output, and a drop output.

4. The optical cross connect of claim 3, wherein the two one-channel add/drop multiplexers each include two 1×2 optical switches and a settable optical attenuator positioned between the main input and the main output.

5. The optical cross connect of claim 2, wherein the junction module includes a plurality of optical splitters each corresponding to one of the MM switches and being configured to couple the drop ports of the sub-module switches to the selective matrices.

6. The optical cross connect of claim 2, wherein the selective matrices are configured to route the selected optical signals to the add ports of the respective sub-module switch.

7. The optical cross connect of claim 1, wherein the selective matrices each comprise:
a first stage of 2×2 optical switches; and
a second stage of 2×1 optical switches.

8. The optical cross connect of claim 1, wherein the plurality of MM switches further comprises:
wavelength-division demultiplexers each coupled to one of the input fibers at the input ports and configured to separate the carrier wavelengths of the optical signals for the sub-module switches; and
wavelength-division multiplexers each coupled to one of the output fibers at the output ports and configured to combine the carrier wavelengths of the optical signals from the sub-module switches.

9. The optical cross connect of claim 8, wherein the plurality of MM switches further comprises:
input signal adapters positioned in an input optical path between the wavelength-division demultiplexers and the sub-module switches; and
output signal adapters positioned in an output optical path between the sub-module switches and the wavelength-division multiplexers.

10. The optical cross connect of claim 1, wherein the cross connect switches up to M×N optical signals, N representing a number of the input optical fibers, and M representing a number of carrier wavelengths an each of the input optical fibers.

11. The optical cross connect of claim 10, wherein each MM switch receives K×M of the optical signals, each MM switch includes M sub-module switches, the junction module includes K selection matrices, and K represents a number of the groups of the input optical fibers.

12. A main module switch for use in switching optical signals with a plurality of carrier wavelengths between input optical fibers and output optical fibers in an optical cross connect, the optical cross connect having a junction module for touting some of the optical signals between the main module switch and other identical main module switches, comprising:
input ports coupled to a group of the input optical fibers,
wavelength-division demultiplexers each coupled to one of the input fibers at the input ports;
output ports coupled to a group of the output optical fibers;
wavelength-division multiplexers each coupled to one of the output fibers at the output ports; and
a plurality of sub-module switches each corresponding to one of the carrier wavelengths and being configured to route optical signals between the input ports, the other MM switches, and the output ports.

13. A main module switch according to claim 12, further comprising input signal adapters positioned in an input optical path between the wavelength division demultiplexers and the sub-module switches.

14. A main module switch according to claim 12, further comprising output signal adapters positioned in an output optical path between the sub-module switches and the wavelength-division multiplexers.

15. The main module switch of claim 12, wherein the each sub-module switch comprises
an add/drop stage having an add port configured to receive an add channel another sub-module switch via the junction module and a drop port configured to output a drop channel to one of the sub-module switches via the junction-module; and
a switching stage configured to route the add channel to any one of the output ports.

16. The main module switch of claim 15, wherein the add/drop stage includes two one-channel add/drop modules each having a main input, an add input, a main output and a drop output.

17. The main module switch of claim 16, wherein the two one-channel add/drop multiplexers each include two 1×2 optical switches and a settable optical attenuator positioned between the main input and the main output.

18. Optical telecommunications network, comprising:
a plurality of transmitting stations for transmitting multiwavelength optical signals,
a plurality of receiving stations for receiving said multiwavelength optical signals,
a plurality of optical fiber lines for connecting said transmitting stations to a cross-connect apparatus,
a plurality of optical fiber lines for connecting said cross-connect apparatus to said receiving stations,
characterized in that said cross-connect apparatus comprises:
a plurality of main module (MM) switches each including
input ports coupled to a group of the input optical fiber lines,
output ports coupled to a group of the output optical fiber lines, and
a plurality of sub-module switches each associated to a respective carrier wavelength of the optical signals and being configured to route the optical signals having the respective carrier wavelength between the input ports, the other of the plurality of MM switches, and the output ports; and
a junction module coupled to the sub-module switches and having
a plurality of selective matrices each corresponding to a respective sub-module switch and being configured to route a selected drop channel from another of the plurality of sub-module switches in the plurality of MM switches as an add channel to the respective sub-module switch.

19. Method to cross-connect multiwavelength optical signals between input optical fibers and output optical fibers, comprising the steps of:
dividing the input and the output optical fibers into groups of fibers,
demultiplexing the multiwavelength optical signals from a first group of input fibers into single wavelength optical signals,
grouping together single wavelength optical signals of a same nominal wavelength from said first group of input fibers,
selecting a group of output signals from said single wavelength optical signals of a same nominal wavelength and from signals from a second group of input fibers, different from the first group of input fibers,
multiplexing said group of output signals to a group of output optical fibers.

20. Method to cross-connect multiwavelength optical signals according to claim 19, wherein said first group of input fibers comprises two optical fibers.
